(19) United States
(12) Patent Application Publication
(10) Pub. No.: US 2002/0173183 A1
(43) Pub. Date: Nov. 21, 2002

(54) Power plug

(76) Inventors: Shinichi Segawa, Kyoto-shi (JP); Seung Heon Lee, Inchon (KR)

Correspondence Address: WENDEROTH, LIND & PONACK, L.L.P., 2033 K STREET N. W., SUITE 800, WASHINGTON, DC, 20006-1021, US

(21) Appl. No.: 10/132,414

(22) Filed: Apr. 26, 2002

(30) Foreign Application Priority Data
Apr. 27, 2001 (JP) 2001-133021

(51) Int. Cl. H01R 13/44; H01R 13/60

(52) U.S. Cl. 439/131

(57) ABSTRACT

A prismatic bar 18 having a square cross-section is provided in a rotation shaft 16 to which plug terminals 14 are fixed, and the rotation shaft 16 is sandwiched between a pair of elastic pieces 17a, 17a of an elastic holder 17, so that the respective elastic pieces 17a, 17a are brought into contact with plane surfaces of the prismatic bar 18 parallel to each other. Therefore, an interval between the two elastic pieces 17a, 17a of the elastic holder 17 is increased when the square bar 18 rotates, and thus, a firm and steady touch of a click can be provided.

### BACKGROUND OF THE INVENTION

1. Field of the Invention

The present invention relates to a power plug with plug terminals provided rotatably with respect to a housing.

2. Description of the Prior Art

Some chargers for a portable electric device have a power plug having a pair of plug terminals that can rotate between a projecting position where tips thereof project from a housing made of synthetic resin and an accommodated position where the tips are housed in an accommodation part of the housing. When using such a charger, the plug terminals is brought to its projecting position for insertion into an outlet, and when the charge is not used, the plug terminals can be accommodated in the housing to be out of the way.

Such power plugs includes one disclosed in Japanese Patent No. 3096896. In this plug, a pair of plug terminals is held by bases thereof embedded into a rotation shaft member made of synthetic resin, and the rotation shaft member is rotatably supported on the housing. By rotating the rotation shaft member, the plug terminals are displaced from the accommodated position where they are accommodated in the housing to the projecting position where they project from the housing. The housing has a pair of elastic pieces, opposed to each other, that is provided integrally therewith near the rotation shaft member, and the rotation shaft member has an engagement pin in the shape of a round bar, the engagement pin entering into a gap between the pair of elastic pieces as the rotation shaft member rotates. The engagement pin expands the gap between the elastic pieces while entering thereto and is held in that position, and thus, the plug terminals is held in the projecting position thereof.

However, in the above described arrangement in which the round-bar-like engagement pin enters by force into the gap between the elastic pieces, a significant displacement of the elastic pieces cannot be set, and a sufficient touch of a click cannot be provided. To enhance the touch of a click, it is needed to upsize the engagement pin or the like. However, due to the restriction on the overall size of the power plug, the upsizing of the engagement pin or the like is also restricted.

This invention ha been devised in view of the above described circumstances, and an object thereof is to provide a power plug capable of providing a firm and steady touch of a click.

### SUMMARY OF THE INVENTION

According to the present invention, a rotation shaft for integrally supporting a set of plug terminals is received on a bearing of a housing, and thus, the plug terminals are supported rotatably with respect to the housing. The rotation shaft comprises a prismatic bar with a peripheral surface including a plurality of plane surfaces and ridges between the plane surfaces, and a pair of elastic pieces positioned to sandwich the rotation shaft therebetween is brought into contact with the plurality of plane surfaces of the prismatic bar. The pair of elastic pieces is arranged not to rotate with the rotation shaft and, as the rotation shaft rotates, is elastically deformed to expand by pressure from the ridge of the prismatic bar. Here, when the rotation shaft is rotated by rotating the plug terminals, the ridges of the prismatic bar press outwardly the elastic pieces, and therefore, the distance between the elastic pieces is repeatedly increased and decreased with the rotation of the rotation shaft. And, a firm and steady touch of a click is provided when the rotation shaft rotates from an angle position where the distance between the elastic pieces is the narrowest to the next angle position where the distance becomes the narrowest once it has become the widest.

In such an arrangement, a large displacement of the elastic pieces can be set according to the cross-section of the prismatic bar, and a more obvious touch of a click can be provided compared to a prior art arrangement in which the round-bar-like engagement pin simply enters into the gap between a pair of elastic pieces.

Furthermore, in the case where the plug terminals are locked at an angle of 90 degrees as in the prior art arrangement described above, the cross-section of the prismatic bar is preferably formed into a square shape. In such an arrangement, the increase and decrease in the distance between the elastic pieces are repeated every 90 degrees of rotation, so that the plug terminals can be rotated with a simple angle interval to provide a touch of a click.

Besides, the elastic pieces are preferably formed as parts separate from the housing and mounted on the housing in a detention state.

In the prior art arrangement described above, in which the elastic pieces are formed integrally with the housing made of resin, it may be difficult to select a material for the elastic pieces that has a sufficient strength, such as elasticity, wear resistance and regidity, or to form the material into a shape with these properties. Therefore, by separating the elastic pieces from the housing, an appropriate material can be used for the elastic pieces, or the elastic pieces can be readily formed into an optimal shape.

### BRIEF DESCRIPTION OF THE DRAWINGS

FIG. 1 is an exploded perspective view of a power plug portion of a charger according to an embodiment of the present invention;

FIG. 2 is a cross-sectional view of the power plug portion taken along the line X-X in FIG. 1, in which plug terminals is in a projecting position;

FIG. 3 is a cross-sectional view of the power plug portion taken along the line X-X in FIG. 1, in which plug terminals is in an accommodated position; and

FIG. 4 is a schematic circuit diagram of an AC adapter having an AC/DC converter circuit.

### DESCRIPTION OF THE PREFERRED EMBODIMENTS

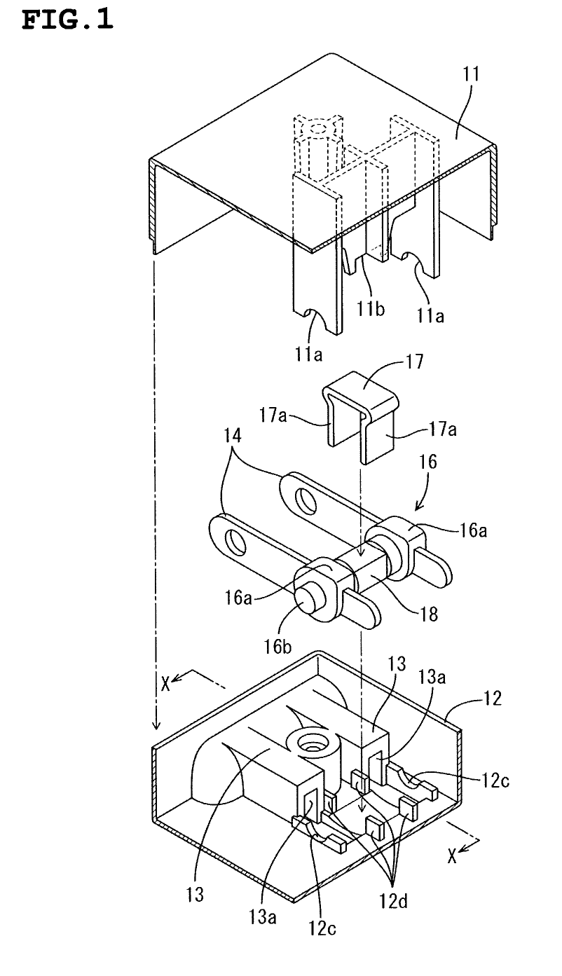

An embodiment of the present invention will be described below with reference to FIGS. 1 to 3.

A power plug in this embodiment is provided in a charger for a portable electric device, for example, in such a manner that plug terminals thereof can rotate with respect to a housing of the charger. In FIG. 1, only the power plug portion of the charger is shown.

As shown in FIG. 1, the charger has plug terminals 14 fixed to a rotation shaft 16, an elastic holder 17 and an AC/DC converter circuit board (not shown) accommodated between an upper case 11 and a lower case 12. The upper case 11 and the lower case 12 are both square cases made of resin and constitute a box-like housing 10 with a space therein by combining them at openings thereof.

The plug terminals 14 are a set of two elongated conductive blades made of metal, which are to be inserted into an outlet of AC Power Supply. The plug terminals are formed integrally with the rotation shaft 16 by piercing through both ends of the shaft, the rotation shaft being made of resin and placed horizontally, and parallel tips of the plug terminals to be inserted into the outlet project forward. The rotation shaft 16 has laterally projecting stoppers 16a, 16a formed on an outer peripheral thereof at positions associated with the positions where the respective plug terminals 14 pierce therethrough. When the plug terminals 14 are in the projecting position, as described later, the stoppers 16a, 16a abut against walls of slits 13a, 13a formed in rear walls of accommodation parts 13, 13 to prevent further rotation of the plug terminals 14. In addition, the rotation shaft 16 has shaft parts 16b, 16b of a smaller diameter formed thereon at positions further outside of the pierced positions.

Here, when the plug terminals 14 are in the projecting position, base portions of the plug terminals 14 projecting rearward from the rotation shaft 16 come into contact with a conductive terminal (not shown) to function as contact terminals for electrically connecting the plug terminals 14 with the AC/DC converter circuit board.

The lower case 12 has, at a forward end thereof, a pair of accommodation parts 13, 13 for accommodating the plug terminals 14, which are formed by pressing a bottom surface of the case into a box-like shape. And, the slits 13a, 13a, through which the plug terminals 14 are to be passed, are formed in the rear walls of the accommodation parts 13, 13. In addition, a pair of bearings 12c, 12c for supporting the shaft parts 16b, 16b of the rotation shaft 16 is provided in a rearward position of the slits 13a, 13a to be offset outwardly from the slits.

The upper case 11 has a pair of pressure pieces 11a, 11a that project downwardly from the ceiling surface so as to oppose to the bearings 12c, 12c of the lower case 12. When the upper case 11 is put on and fixed to the lower case 12, the pressure pieces 11a, 11a are placed to cover the top surfaces of the shaft parts 16b, 16b of the rotation shaft 16 supported by the bearings 12c, 12c of the lower case, thereby holding the rotation shaft 16 rotatably without floating upward.

By the arrangement as described above, the pair of plug terminals 14 can be rotated with respect to the housing 10 between the projecting position where the tips thereof project downwardly and the accommodated position where the tips are accommodated in the accommodation parts 13, 13 with being directed forwardly. When the plug terminals 14 are in the projecting position, the stoppers 16a, 16a that are formed on the rotation shaft 16 abut against the walls of the slits 13a, 13a, and when they are in the accommodated position, the tips of the plug terminals 14 abut against the ceiling surface of the accommodation parts 13, 13. Therefore, the plug terminals 14 are prevented from rotating beyond an angle range of about 90 degrees between the positions.

In this embodiment, the rotation shaft 16 for holding the plug terminals 14 has a center portion formed into a prismatic bar 18 in which a cross-section perpendicular to the axial direction thereof is a square. The prismatic bar 18 is designed so that a set of parallel faces thereof is parallel with a longitudinal direction of the plug terminals 14 and another set of parallel faces thereof is perpendicular to the longitudinal direction of the plug terminals 14.

An elastic holder 17 is a member made of resin and having a high elasticity and comprises a pair of elastic pieces 17a, 17a for holding the prismatic bar 18 along the opposed sides of the square-shaped cross-section and a connecting portion for interconnecting the pieces, the pair of elastic pieces and the connecting portion being formed integrally. That is, the interval between the pair of elastic pieces 17a, 17a opposed to each other is substantially the same as the length of one side of the square-shaped cross-section of the prismatic bar 18 of the rotation shaft 16. As shown in FIGS. 1 to 3, the connections between the respective elastic pieces 17a, 17a and the connecting portion are made thicker than the other portions, and inner walls thereof are curved surfaces having circular cross-sections. This is intended for avoiding concentration of stress on these bent portions when a bias by the prismatic bar 18 of the rotation shaft 16 occurs.

The elastic holder 17 is mounted from the above in such a manner that the tips of the elastic pieces 17a, 17a are directed downwardly and the prismatic bar 18 of the rotation shaft 16 supported by the bearings 12c, 12c are sandwiched between the elastic pieces. The mounted elastic holder 17 is limited in its movement in the axial direction of the rotation shaft 16 by four projections 12d provided on the bottom surface of the lower case 12. In addition, when the upper case 11 is put on and fixed to the lower case 12, the elastic holder 17 is limited also in its upward movement by a pressure piece 11b abutting against the top surface of the elastic holder 17, the pressure piece 11b having a tip end of an angled U-shape and formed between the pressure pieces 11a, 11a of the upper case 11. Thus, the elastic holder 17 (elastic pieces 17a, 17a) is not associated with the rotation of the rotation shaft 16 and mounted on the housing 10 in a detention state.

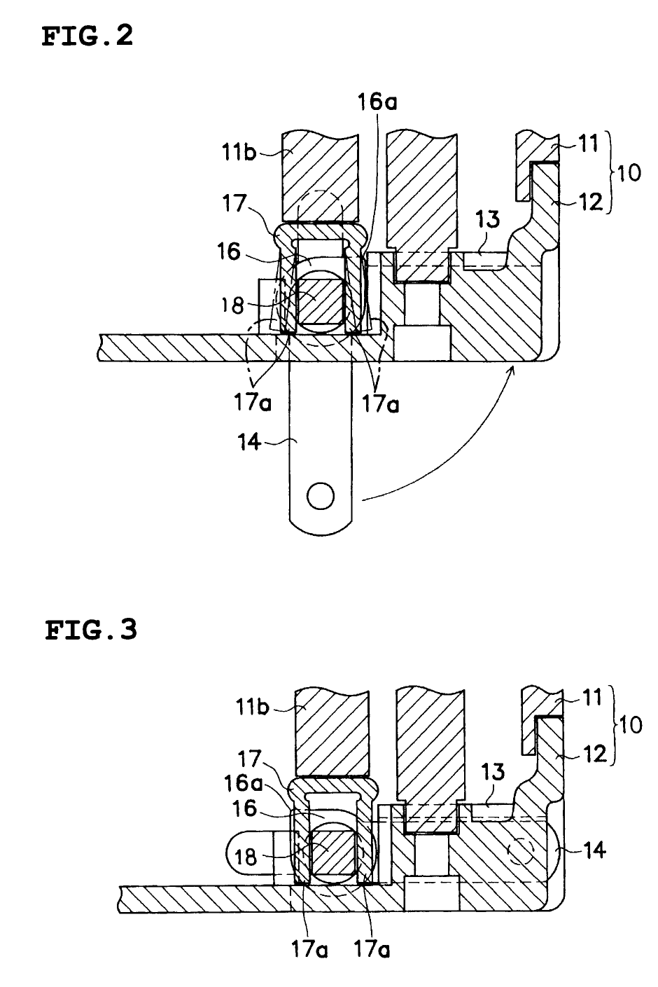

Now, an action of the above described arrangement during rotation of the plug terminals 14 will be described with reference to FIGS. 2 and 3.

FIG. 2 is a cross-sectional view of the power plug portion at the time when the plug terminals 14 are in the projection position. At this time, one pair of parallel surfaces of the prismatic bar 18 is parallel to the elastic pieces 17a, 17a of the elastic holder 17. Therefore, the elastic pieces 17a, 17a are in contact with the parallel surfaces of the prismatic bar 18 with the narrowest interval therebetween, and thus, the plug terminals 14 are locked not to be readily rotated. If the plug terminals 14 are forcedly rotated to an angle less than 45 degrees to rotate the prismatic bar 18, the rotation shaft 16 receives a force to return to the original position from the restoring force of the elastic pieces 17a, 17a expanded as indicated by the alternate long and short dashed line in the drawing. However, if the plug terminals 14 are forcedly rotated to an angle equal to or more than 45 degrees, the restoring force of the elastic pieces 17a, 17a exerted on the prismatic bar 18 becomes a force to further rotate the rotation shaft 16 to 90 degrees, and thus, the tips of the plug terminals 14 can be directed forward and accommodated in the accommodation parts 13, 13, as shown in FIG. 3. The same goes for the case where the plug terminals 14 is rotated in the opposite direction to be in the projection position.

As described above, the power plug according to this embodiment is arranged so that the prismatic bar 18 of the rotation shaft 16 is sandwiched between the pair of elastic pieces 17a, 17a that is mounted on the housing 10 in the detention state. This arrangement can provide a firm and steady touch of a click when the plug terminals 14 are rotated compared to a prior art arrangement in which the round-bar-like engagement pin simply enters into the gap between a pair of elastic pieces. Furthermore, since the outer peripheral of the prismatic bar 18 slides along a pair of elastic pieces 17a, 17a, wear of both members 17 and 18 due to the rotation of the plug terminals 14 can be suppressed and a good touch of a click can be maintained for a long time compared to the prior art arrangement in which the engagement pin is susceptible for deformation, wear and the like during the rotation.

Since the interval between the elastic pieces 17a, 17a of the elastic holder 17 is repeatedly increased and decreased with the rotation of the prismatic bar 18 of the rotation shaft 16, the elastic holder is needed to have an appropriate strength in terms of elasticity, wear resistance, rigidity and the like. Therefore, the elastic holder 17 is preferably made of a material that is different from that of the housing 10 and superior particularly in the above properties. In this embodiment, the elastic holder 17 is a part separate from the upper case 11 and the lower case 12 and thus, the elastic holder 17 can be made of any material freely selected and formed into any shape regardless to the material of the housing 10.

Furthermore, since the elastic holder 17 with a pair of elastic pieces 17a, 17a for sandwiching the prismatic bar 18 is integrally formed, it can be easily mounted on the housing 10.

<Other embodiments>

The present invention is not limited to the above described embodiment, for example, embodiments as described below fall within the technical scope of this invention, and various other modifications are possible without departing from the spirit of this invention.

(1) In the above described embodiment, the prismatic bar 18 is provided at the center portion of the rotation shaft 16. However, the prismatic bar may be provided at any position on the rotation shaft 16 including both ends thereof, for example.

(2) In the above described embodiment, the plug terminals 14 rotates only within the angle range of 90 degrees. However, the plug terminals may rotate within a wider angle range including 360 degrees and a touch of a click may be produced every 90 degrees. Besides, the plug terminals may not be accommodated in the housing 10. For example, the power plug may have the plug terminals that always project externally and can rotate with respect to the housing 10 in this state.

(3) In the above described embodiment, the cross-section of the prismatic bar 18 is a square. However, it is not limited thereto and may be a regular triangle or any other regular polygon. In this case, the plug terminals 14 rotates while producing a touch of a click every angle position corresponding to the number of vertices of the regular polygon. Alternatively, any polygon other than a regular polygon is possible. In this case, the angle positions in the rotation of the plug terminals 14 are irregular, so that the touch of a click can be varied. In addition, the vertices of the polygon of the cross-section of the prismatic bar 18 may be chamfered or formed into curved surfaces having circular cross-sections to reduce the resistance during the rotation of the plug terminals 14.

(4) In the above described embodiment, the elastic holder 17 having the two opposed elastic pieces 17a, 17a formed integrally therewith has been described. However, the elastic pieces 17a, 17a may be separate plate members and provided separately on the upper case 11 and the lower case 12 so as to be opposed to each other.

(5) In the above described embodiment, the prismatic bar 18 is sandwiched between the surfaces of the pair of elastic pieces 17a, 17a that are opposed substantially in parallel to each other. However, the shape of the opposed surfaces may be arbitrarily determined according to the cross-section of the prismatic bar 18.

For example, if the cross-section of the prismatic bar 18 is a polygon having an odd number of vertices, such as a regular pentagon, the parallel surfaces may sandwich the prismatic bar therebetween with only one of the surfaces being along a side of the prismatic bar 18, or alternatively, the other of the surfaces may be formed into a depressed shape so as to be along the angled portion of the prismatic bar 18.

Furthermore, if both the opposed surfaces of the elastic holder 17 are formed into a depressed shape, the prismatic bar 18 having a cross-section of a polygon with an even number of vertices can be sandwiched by the holder with ridges thereof on both sides being along the opposed surfaces.

(6) In the above described embodiment, the prismatic bar 18 is sandwiched between the opposed surfaces of the elastic holder 17. However, the prismatic bar 18 may be sandwiched between two bars or the like.

(7) In the above described embodiment, the elastic holder 17 is apart separate from the housing 10. However, so far as a sufficient strength can be attained in terms of elasticity and the like, the elastic holder may be constituted by two projections provided on the case 11 or case 12. This arrangement allows the assembly of the power plug to be simplified.

(8) In the above described embodiment, the power plug for a charger with a set of two plug terminals 14 has been described. However, a power plug with a set of three or more plug terminals 14 or with a grounding terminal along with the plug terminals 14 may be implemented similarly.

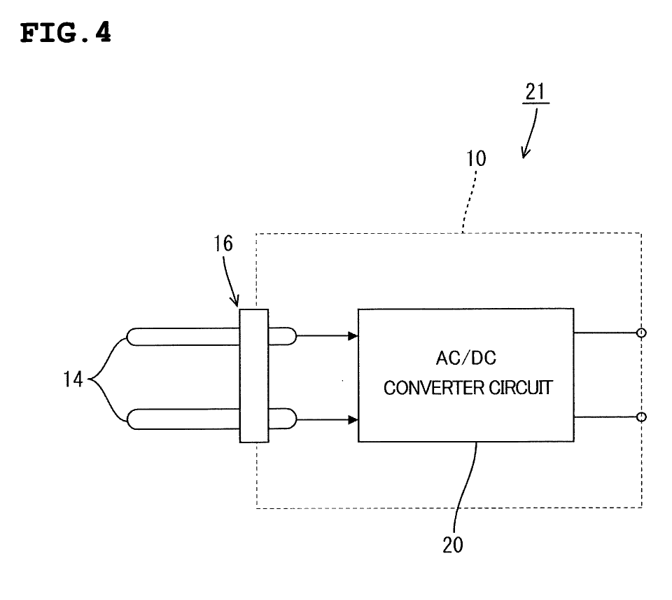

(9) In the above described embodiment, an example in which the power plug is provided in the charger for a secondary battery integrated in a portable electric device or the like has been described. However, an installation portion 5 may be separated from the charger and implemented in an AC adapter 21 that conducts only conversion to a DC voltage with an AC/DC converter circuit 20 (see FIG. 4) or in a typical power plug without the AC/DC converter circuit 20 or the like. Furthermore, this invention may be applied to any device other than the charger so far as the device has a power plug.

What is claimed is:

1. A power plug, comprising:
a set of plug terminals;
a rotation shaft for integrally holding the plug terminals with spaced apart from each other, the rotation shaft having a prismatic bar with a peripheral surface including a plurality of plane surfaces and ridges between the plane surfaces;
a housing having a bearing for rotatably supporting said rotation shaft; and
a pair of elastic pieces that is positioned to sandwich said rotation shaft and brought into contact with said plurality of plane surfaces of said prismatic bar, the elastic pieces being arranged not to rotate with said rotation shaft and, as the rotation shaft rotates, being elastically deformed to expand by pressure from said ridge of said prismatic bar.

2. The power plug according to claim 1, wherein said prismatic bar is a square bar.

3. The power plug according to claim 1, wherein said pair of elastic pieces is separate from said housing and mounted on the housing in a detention state.

4. The power plug according to claim 2, wherein said pair of elastic pieces is separate from said housing and mounted on the housing in a detention state.

5. The power plug according to claim 3, wherein said prismatic bar of said rotation shaft has an even number of plane surfaces, and said elastic pieces of the pair, which are brought into contact with the plane surfaces of said prismatic bar that are parallel to each other, are connected at one end thereof to each other by a connecting portion.

6. A power plug, comprising:
a set of plug terminals;
a rotation shaft for integrally holding the plug terminals with spaced apart from each other, the rotation shaft having a prismatic bar with a peripheral surface including a plurality of plane surfaces and ridges between the plane surfaces;
a housing having a bearing for rotatably supporting said rotation shaft and an accommodation part capable of accommodating said plug terminals, said accommodation part accommodating said plug terminals therein when said rotation shaft is rotated from a projecting position where said plug terminals project from the housing to an accommodated position; and
a pair of elastic pieces that is positioned to sandwich said rotation shaft and brought into contact with said plurality of plane surfaces of said prismatic bar, the elastic pieces being arranged not to rotate with said rotation shaft and, as the rotation shaft rotates, being elastically deformed to expand by pressure from said ridge of said prismatic bar.

7. The power plug according to claim 6, wherein a converter circuit for converting an alternating current to a direct current is housed in said housing, and an alternating current input of the converter circuit is connected to said plug terminals.

8. The power plug according to claim 6, wherein said prismatic bar is a square bar.

9. The power plug according to claim 6, wherein said pair of elastic pieces is separate from said housing and mounted on the housing in a detention state.

10. The power plug according to claim 6, wherein said prismatic bar of said rotation shaft has an even number of plane surfaces, and said elastic pieces of the pair, which are brought into contact with the plane surfaces of said prismatic bar that are parallel to each other, are connected at one end thereof to each other by a connecting portion.

11. The power plug according to claim 7, wherein said prismatic bar is a square bar.

12. The power plug according to claim 7, wherein said pair of elastic pieces is separate from said housing and mounted on the housing in a detention state.

13. The power plug according to claim 7, wherein said prismatic bar of said rotation shaft has an even number of plane surfaces, and said elastic pieces of the pair, which are brought into contact with the plane surfaces of said prismatic bar that are parallel to each other, are connected at one end thereof to each other by a connecting portion.
